(19) United States
(12) Patent Application Publication
(10) Pub. No.: US 2004/0012205 A1
(43) Pub. Date: Jan. 22, 2004

(54) Modified continuous energy supplier (M.C.E.S.)

(76) Inventor: Dalmacio (Dale) E. Sua-An, Cherry Hill, NJ (US)

Correspondence Address: Dalmacio (Dale) E. Sua-An, 28 Greensward, Cherry Hill, NJ, 08002-4703, US

(21) Appl. No.: 10/196,261

(22) Filed: Jul. 17, 2002

(51) Int. Cl. H02P 9/00

(52) U.S. Cl. 290/40 C

(57) ABSTRACT

The Modified Continuous Energy Supplier: a method of generating electricity on board a moving Electric Vehicle for the recharging of the batteries and the continuous energizing of the propulsion motor in which the generating system converts into electricity the mechanical energy in the moving Electric Vehicle.

The batteries are recharged on board whenever the Vehicle is in motion, thus enabling the batteries to continuously energize the propulsion motor and make the Electric Vehicle operate continuously even when it slows down or stops before traffic lights.

The process eliminates not only the frequent stopping for recharging of the batteries but also the use of fossil fuels which produce emission.

With the on board recharging of its batteries and the continuous energizing of its propulsion motor, the Electric Vehicle with the Modified Continuous Energy Supplier is able to operate continuously, run powerfully, and perform reliably like the gasoline-powered Vehicles.

### CROSS-REFERENCES TO RELATED APPLICATIONS

This new Application is a modification of the patent application Ser. No. # 09/041/042 filed last Jun. 26, 1998, entitled “The Continuous Energy Supplier”, which was allowed to go abandoned last Jul. 19, 2000. Since the improvement of my basic Application is different enough to be unobvious over the basic invention, this is, therefore, an entirely new, separate, independent Application. It contains new subject matter and new claims. The process of generating electricity and of recharging the batteries in the previous and in this new Application is similar, but the renewable source of energy and the driver of the Generator are different. In stead of making use of wind power technology to generate electricity, the Modified Continuous Energy Supplier converts the mechanical energy of the rotating wheels into electrical energy or electricity for the on board recharging of the batteries and the continuous energizing of the propulsion motor.

### STATEMENT REGARDING FEDERALLY SPONSORED RESEARCH AND

DEVELOPMENT. The Federal Government through the Department of Energy has been sponsoring Energy-related researches in cooperation with Car Manufacturers. Millions of U.S. dollars have been invested in researches on Electric Vehicles, especially on quality Traction Batteries, as a solution to the problem of emission. In spite of the millions of dollars of Federal funding, so little has been accomplished towards the perfection of Electric Vehicles, and the problem of limited driving range in Electric Vehicles and of emission still remains to be solved.

### REFERENCE TO “MICROFICHE APPENDIX”

Not Applicable

### BACKGROUND OF THE INVENTION

1. Field of the Invention

The Modified Continuous Energy Supplier is an energy-related invention. It tries to solve the problem of emission by eliminating the use of fossil fuels in Vehicles. It introduces in Electric Vehicles a clean electricity-generating system which recharges on board the batteries which continuously energize the propulsion motor, thus, making Electric Vehicles operate, run and perform reliably like the gasoline-powered vehicles, and without producing emission

2. Description of Related Art including information disclosed under 37 CFR 1.97 & 1.98.

In his researches, the Applicant has not found any related Art which tries to solve the problem of limited driving range in Electric Vehicles by installing a generating system which converts the mechanical energy of the rotating wheels into electricity and recharges the batteries on board the Electric Vehicle while the Electric Vehicle is running. Currently, there are researches on “fuel cells” and other technologies for energizing Vehicles without producing emission. But the Applicant is not aware of any invention or experiment on the conversion into electricity of the mechanical energy of rotating wheels of the Electric Vehicle for the on board recharging of the batteries and the continuous energizing of the Electric Vehicle's propulsion motor.

### BRIEF SUMMARY OF THE INVENTION

Electric Vehicles are a good solution to the ever-worsening problem of emission which causes global warming and destroys the environment and human health However, all Electric Vehicles have the problem of limited driving range, because they depend primarily on batteries which naturally discharge in use. And frequent stopping to recharge the Vehicle's batteries causes a lot of inconvenience to the commuters. These make Electric Vehicles unreliable and undesirable.

The Modified Continuous Energy Supplier attempts to solve this problem by providing a means for recharging the batteries on board while the Electric Vehicle is running. It makes use of a generating system which converts into electricity the mechanical energy of the rotating wheels in a moving Vehicle. The generator of the M.C.E.S. Generating System is driven by a belt or chain that is connected either directly to the geared shaft of the Vehicle's regular wheels or to the geared shaft of a separate wheel or pair of wheels which rotate when the Vehicle is in motion.

With the Modified Continuous Energy Supplier, the batteries are recharged on board, when the Electric Vehicle is running, and the propulsion motor is continuously energized by the batteries, thus, making Electric Vehicles with Modified Continuous Energy Supplier perform reliably like the gasoline-powered Vehicles.

### DESCRIPTION OF THE PRIOR ART

The common means of transportation are either diesel or gasoline-powered and are reliable. However, the use of fossil fuels in Vehicles produces emission which causes untold environmental and health problems and global warming that is hurting the earth and its inhabitants. Several alternative fuels have been experimented without success. Fuel cells are being perfected and predicted to be the fuel of the new millennium. However, it will make Vehicles very expensive because of the complicated mechanism required to produce power from fuel cells. This leaves the Electric Vehicles powered by batteries as still the potentially better alternative. With the Modified Continuous Energy Supplier, Electric Vehicles will become the cleanest, very affordable, and reliable Vehicle of the new millennium.

### OBJECTS AND ADVANTAGES

Accordingly, several objects and advantages of this invention are:

1. It does not require the use of fossil fuel; thus, produces no emission.

2. The EV with Modified Continuous Energy Supplier does not have to stop for recharging or refueling.

3. It eliminates expenses for fuel and maintenance.

4. Its Generating System can generate either ac or dc power.

5. It can generate all the power needed to energize Vehicles of any capacity or horse power by simply changing the capacity or out-put of the generator.

6. The invention can be applied not only to Electric Vehicles but also to locomotives or trains and to other means of transportation that have wheels.

7. It has simple mechanism and does not require many expensive components, so it will make Electric Vehicles very affordable.

8. It eliminates the billions of dollars spent on oil importation, which not only endangers but actually destroys the environment because of oil spills.

9. It eliminates dependence on fossil fuels and subservience to those who produce and control these exhaustible resources.

10. Above all, it eliminates emission, which destroys the environment & human health and worsens the global warming.

Further objects and advantages of this invention will become apparent from the consideration of the drawings and ensuing descriptions, and of the claims.

### DRAWING FIGURES

FIG. I=Cutaway View of the EV with Modified Continuous Energy Supplier.

FIG. 2-a=Perspective View of the M.C.E.S. generating system utilizing a separate wheel or pair of wheels with geared shaft that rotates, when the vehicle is in motion, and spins the belt or chain that drives the generator of the M.C.E.S. generating system.

FIG. 2-b=Perspective View of the M.C.E.S. Generating System in which the Generator's geared shaft is rotated by a belt or chain that is connected directly to the specially geared shaft of either the front or rear wheels of the Electric Vehicle.

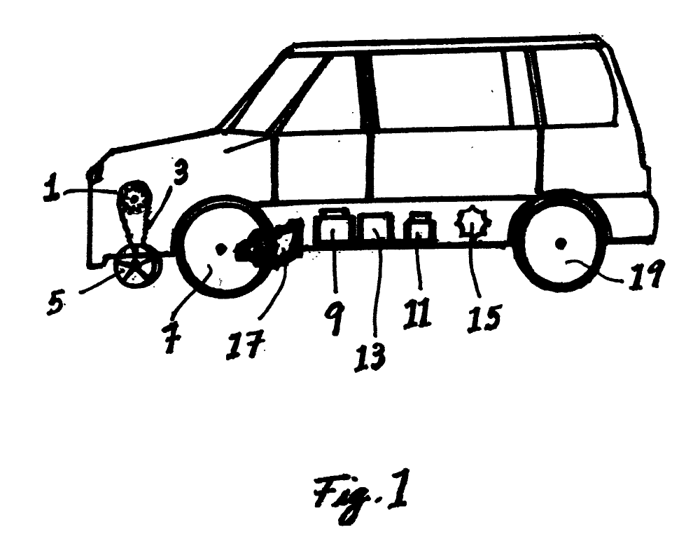

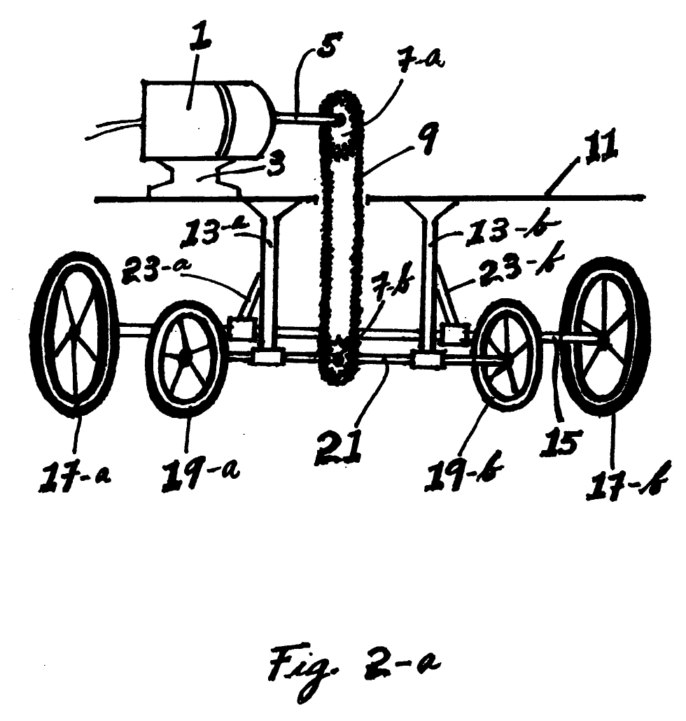

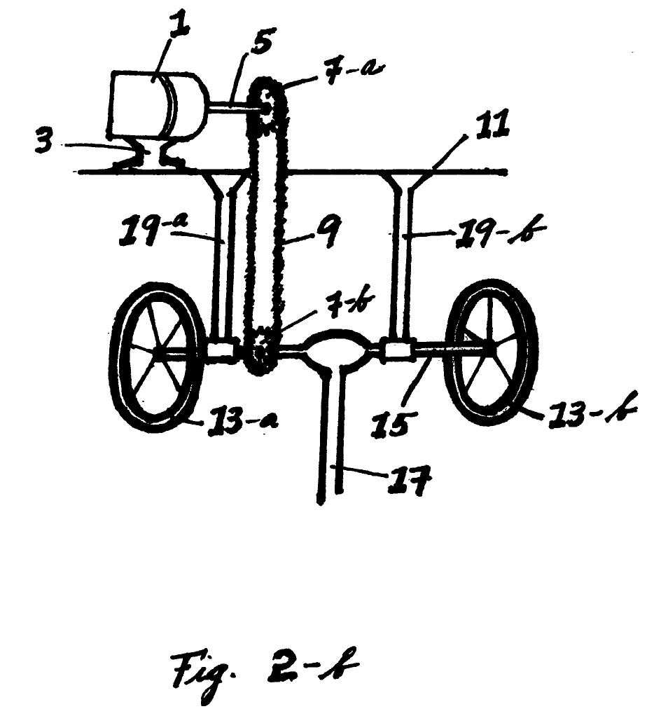

N.B. The M.C.E.S. generating system designs illustrated in FIGS. 2-a and 2-b can be applied to all types of Electric Vehicles and automobiles as well as to locomotives or trains and other means of transportation having wheels.

### REFERENCE NUMERALS IN DRAWINGS AND DESCRIPTION OF THE COMPONENTS:

FIG. 1

# 1=Generator

# 3=Chain or belt

# 5=A separate wheel or pair of wheels-.

# 7=Front wheels of the Electric Vehicle

# 9=Traction Battery

# 11=Spare Battery

# 13=Step-down Transformer

# 15=Power Center/Panel

# 17=Propulsion Motor

# 19=Rear wheels

FIG. 2-a

# 1=Generator

may be either an ac or dc generator, depending on the type of propulsion motor being used, and with out-put that is capable of recharging the batteries and of energizing the propulsion motor at the same time.

automatically recharges the batteries and automatically takes over the energizing of the propulsion motor when the Vehicle runs steadily at a speed that makes the generator generate the specified out-put.

# 3=Support bracket of the generator

secures the generator properly in place

# 5=Shaft of the generator

spins the rotor of the generator

# 7-a=Shaft gear of the generator

# 7-b=Shaft gear of the wheel(s)

# 9=Chain or belt

driver of the generator

connects the generator's geared shaft to the geared shaft of a separate wheel or pair of wheels.

drives or spins the generator's geared shaft to make the generator generate electricity when the wheels rotate.

# 11=The floor of the Vehicle or the prop of the generator in the engine compartment.

# 13-a & 13-b=Support brackets—which secure and hold in place the geared shaft of the separate wheel or pair of wheels.

# 15=Normal wheel shaft of the Vehicle

# 17-a & 17-b=The normal wheels of the Vehicle.

# 19-a & 19-b=Separate wheel or pair of wheels

with tires that rotate whenever the Vehicle moves. The tires may preferably be made of solid rubber in order to prevent flat tires and eliminate the hazel and inconvenience of changing tires whenever these become flat. They should also be of the appropriate size that could make the generator generate the specified output at the specified mph speed of the Vehicle.

# 21=geared shaft of the separate wheel or pair of wheels

properly and securely fastened to the Vehicle

# 23-a & 23-b=pair of shock absorbers to keep wheels steady on the ground, while making them flexible in rough terrains and humps.

FIG. 2-b

# 1=Generator

#3=Support bracket of the generator

# 5=Shaft, which rotates the rotor of the generator

# 7-a=Shaft gear of the generator

# 7-b=Shaft gear of the wheel(s)

# 9=Chain or belt

# 11=Floor of the Vehicle or prop of the generator in the engine compartment.

# 13-a & 13-b=The normal wheels of the Vehicle.

# 15=The shaft of the wheels of the Vehicle

# 17=Drive shaft

# 19-a & 19-b=Support brackets of the wheel shaft

Description and Operation—Alternative Embodiment

While the preceding descriptions contain many specificities, these should not be construed as limitations on the scope of this invention, but rather as an exemplification of one preferred embodiment thereof Many other variations and configurations are possible. The use of a separate wheel or pair of wheels with solid rubber tires and geared shaft to produce mechanical energy which is converted into electricity is a unique and original feature in Electric Vehicles.

Although most of the components in the M.C.E.S. generating system are specified in this Application, the Specialists and Experts in the field will have to determine, in the process of construction and manufacture, the most appropriate and exact specifications of each component used that will work best in a particular case or situation.

Accordingly, the scope of this invention should be determined not only by the embodiments illustrated, examples and descriptions given, but also by the appended claims and their legal equivalents.

It is only the primary purpose of the Inventor/Applicant to introduce in Electric Vehicles a method or process of generating electricity by converting mechanical into electrical energy for on board recharging of the batteries and energizing of the propulsion motor in order to extend indefinitely the driving range of Electric Vehicles and make them perform powerfully, efficiently, and reliably like the gasoline-powered Vehicles.

### DESCRIPTION OF THE INVENTION

The Modified Continuous Energy Supplier (M.C.E.S.) is a process of generating electricity by converting the mechanical energy of the rotating wheels into electricity for recharging the batteries on board while the Electric Vehicle is in motion. The M.C.E.S. Generating System (FIG. 2-a) comprises a generating machine or generator 1 whose geared shaft 5 & 7-a is rotated or driven by a chain 9 that is connected either directly to the specially geared shaft 15 of the Electric Vehicle's wheels 7-a & 17-b or to the geared shaft 21 of a separate wheel or pair of wheels 19-a & 19-b that rotate when the Vehicle is moving The generator not only recharges the batteries on board but also automatically takes over the energizing of the propulsion motor, once it has stabilized at its rated or specified out-put. This keeps the batteries always charged and ready to energize the propulsion motor, whenever needed.

With its batteries frequently recharged on board and its propulsion motor continuously energized, the Electric Vehicle with Modified Continuous Energy Supplier is able to operate, run and perform reliably like the gasoline-powered Vehicles without need to stop for refueling or for recharging.

Consequently, the Electric Vehicle is able to deliver sufficient horse power to speed up to the desired maximum mph speed, to offset the aerodynamic drag, wheel drag and overloads, to overcome adverse conditions and circumstances which may slow down or strain the Electric Vehicle, like the slow traffic, icy and slippery roads, ascending slopes, rough terrains, heavy snow, rain storms, cold weather, etc. . . .

The Modified Continuous Energy Supplier will not only solve the problem of limited driving range in Electric Vehicles but also the problem of emission With its simple mechanism, fewer and inexpensive components, the Electric Vehicle with Modified Continuous Energy Supplier will become the very affordable and the most desirable

Process in the Operation of the Invention

Steps:

1. The Ignition Switch is turned “on” to connect the traction battery to the propulsion motor to start the Electric Vehicle's operation

2. Then, the Accelerator is depressed to regulate the speed of the Electric Vehicle.

3. When the Electric Vehicle moves and picks up speed, so do the wheels that rotate the geared shaft which spins the chain that drives the generator.

4. The mechanical energy produced by the turning wheels, when the Vehicle is moving, is converted into electrical energy or electricity by the generator driven by a chain that is connected to the geared shaft of the wheel(s).

5. The generated power is fed to the Power Center and then used to recharge the batteries .

6. When the Vehicle speeds up to the specified mph speed especially in Express Ways and the generator reaches the specified output, the generator automatically takes over the energizing of the propulsion motor, and at the same time recharges the batteries.

7. When the Electric Vehicle slows down or stops before traffic lights and the generator stops generating electricity, the traction battery automatically takes over the energizing of the propulsion motor. When the traction battery fails, the spare battery automatically takes over the energizing of the propulsion motor.

Thus, with the frequently recharged batteries and continuously energized propulsion motor, the Electric Vehicle with Modified Continuous Energy Supplier operates continuously, runs powerfully, and performs reliably like the gasoline-powered Vehicles.

I claim:

1. A method of generating electricity and recharging batteries on board a moving Electric Vehicle in which the generating system converts the mechanical energy of the rotating wheels of said moving Electric Vehicle into electricity for recharging the batteries and/or energizing the propulsion motor of said Electric Vehicle, the electricity-generator of said generating system being driven by a means engaged to the geared shaft of the wheels of said Electric Vehicle or to the geared shaft of a separate wheel or pair of wheels which rotate whenever said Electric Vehicle moves, said method comprising the steps of:
1.a starting and putting said Electric Vehicle in motion to produce mechanical energy with its wheels,
1.b converting said mechanical energy of the rotating wheels of said Electric Vehicle into electricity by capturing and transferring said mechanical energy from the rotating wheels to an electricity-generator through a means that spins the geared shaft of said generator to make it generate electricity,
1.c feeding the generated electricity to the power center which processes and distributes said generated electricity for recharging the batteries and/or energizing the propulsion motor of said Electric Vehicle,
1.d recharging on board said batteries with said generated electricity, while said Electric Vehicle is in motion,
1.e making said generator automatically take over the direct energizing of said propulsion motor of said Electric Vehicle, whenever said Electric Vehicle speeds up to and stabilizes at the specified mph speed and said generator reaches and stabilizes at the specified out-put, while recharging said batteries at the same time,
whereby, with the on board recharging of its batteries and the continuous energizing of its propulsion motor, said Electric Vehicle with the Modified Continuous Energy Supplier is able to operate, run and perform reliably like the gasoline-powered Vehicles.

2. The generating system of claim 1, comprising:
2.a device for generating electricity which is used for recharging the batteries and/or energizing the propulsion motor of said Electric Vehicle of claim 1,
2.b a system of moving parts for transmitting motion, properly and securely engaged to the shaft of said device for generating electricity and to the shaft of the wheels of said Electric Vehicle,
2.c means for sustaining tensile load and for transmitting motion from the geared shaft of the rotating wheels of said Electric Vehicle or from a separate wheel or pair of wheels to the geared shaft of said device for generating electricity,
2.d revolving bars for transferring force by cogs or belts, properly and securely engaged one to said device for generating electricity and the other to said wheels, said revolving bars rotate whenever said Vehicle is in motion,
2.e circular means for producing mechanical energy which revolve whenever said Electric Vehicle is in motion,
2.f mechanism which automatically regulates and maintains the specified revolution per minute of the shaft of said device for generating electricity to make said device for generating electricity continuously, steadily and properly generate its specified output, while said Electric Vehicle in motion frequently changes its mph speed,
whereby, said generating system is able to generate electricity on board said Electric Vehicle in motion and to recharge said batteries which energize the propulsion motor of said Electric Vehicle, thus making said Electric Vehicle with Modified Continuous Energy Supplier operate, run and perform reliably like the gasoline-powered vehicles.
